(19) United States
(12) Patent Application Publication
(10) Pub. No.: US 2026/0073303 A1
(43) Pub. Date: Mar. 12, 2026

(54) LEARNING DATA GENERATION METHOD, INFORMATION PROCESSING DEVICE, AND NON-TRANSITORY COMPUTER READABLE STORAGE MEDIUM

(71) Applicant: Panasonic Intellectual Property Management Co., Ltd., Osaka (JP)

(72) Inventors: Yasunori ISHII, Osaka (JP); Shota Onishi, Osaka (JP); Akihiro Noda, Osaka (JP); Kazuki Kozuka, Osaka (JP)

(21) Appl. No.: 19/343,492

(22) Filed: Sep. 29, 2025

Related U.S. Application Data
(63) Continuation of application No. PCT/JP2024/003271, filed on Feb. 1, 2024.

(30) Foreign Application Priority Data
Mar. 31, 2023 (JP) 2023-057885

(51) Int. Cl. G06N 20/00

(52) U.S. Cl. CPC G06N 20/00

(57) ABSTRACT

First data that is at least one of data used for machine learning of a recognition model that recognizes a feature related to a predetermined scene and data erroneously recognized by the recognition model is acquired, first metadata indicating a characteristic of the first data is generated, second data related to a scene different from the predetermined scene is acquired, second metadata indicating a characteristic of the second data is generated, whether to newly select the second data as third data to be used for the machine learning based on a similarity between the first metadata and the second metadata is determined, and the third data is output.

### FIELD OF INVENTION

The present disclosure relates to a technique for generating learning data used for machine learning.

### BACKGROUND ART

In recent years, a technology of recognizing a feature related to a predetermined scene that can occur at a predetermined place from data acquired at the predetermined place using a recognition model generated by machine learning such as deep learning has been put into practical use. In order to improve the recognition accuracy by the recognition model, it is necessary to perform machine learning using a large amount of data of various scenes similar to a scene (domain) of which the recognition model is an inference target. However, it takes a lot of time to collect a large amount of data of various scenes similar to the scene to be inferred by the recognition model.

Patent Literature 1 describes that whether a fire has actually occurred at the time of a fire alarm on the site is determined, and a monitoring image of the site to which a label indicating a determination result is given is used for machine learning of a recognition model for recognizing whether a monitoring image of the site is a fire site image.

However, in Patent Literature 1, it is not considered to newly add data related to a similar scene while being different from a scene to be inferred by a recognition model as data to be used for machine learning of the recognition model.

Patent Literature 1: Japanese Patent No. 6862144

### SUMMARY OF THE INVENTION

The present disclosure has been made to solve such a problem, and an object of the present disclosure is to provide a technology capable of efficiently adding data regarding a similar scene different from a scene targeted by a recognition model as new data used for machine learning of the recognition model.

An information processing method according to one aspect of the present disclosure is a method for generating learning data used for machine learning of a recognition model that recognizes a feature related to a predetermined scene in a computer, the method including: acquiring first data that is at least one of data used for the machine learning and data erroneously recognized by the recognition model; generating first metadata indicating a characteristic of the first data; acquiring second data related to a scene different from the predetermined scene; generating second metadata indicating a characteristic of the second data; determining whether to newly select the second data as third data to be used for the machine learning based on a similarity between the first metadata and the second metadata; and outputting the third data.

### BRIEF DESCRIPTION OF THE DRAWINGS

FIG. 1 is a diagram illustrating an overall configuration of an information processing system according to an embodiment of the present disclosure.

FIG. 2 is a diagram illustrating an example of first metadata.

FIG. 3 is a diagram illustrating an example of second metadata.

FIG. 4 is a diagram illustrating an example of a distribution of characteristics in which a degree of local distribution is lower than a predetermined degree.

FIG. 5 is a diagram illustrating an example of a distribution of characteristics in which a degree of local distribution is higher than a predetermined degree.

FIG. 6 is a diagram illustrating a first example of a selection screen.

FIG. 7 is a diagram illustrating a second example of a selection screen.

FIG. 8 is a diagram illustrating a calculation example of a detailed similarity.

FIG. 9 is a diagram illustrating an example of an operation screen.

FIG. 10 is a diagram illustrating a first example of a metadata display screen.

FIG. 11 is a diagram illustrating a second example of a metadata display screen.

FIG. 12 is a flowchart presenting an example of the processing of a server.

### DETAILED DESCRIPTION

### Knowledge Underlying Present Disclosure

In recent years, a technology of recognizing a feature related to a predetermined scene that can occur at a predetermined place from data acquired at the predetermined place using a recognition model generated by machine learning such as deep learning has been put into practical use. Here, the scene is, for example, a scene before and after work is performed, a scene during work, a scene in which an abnormality occurs, and the like at a predetermined place such as a care site, a manufacturing site, and a shipping site, and is a scene that can occur at the place. The feature related to the scene is, for example, an object appearing in the scene, a place and time at which data indicating the scene is generated, and the like.

In order to improve the accuracy of recognition by the recognition model, it is necessary to perform machine learning using a large amount of data of various scenes similar to a scene to be inferred. However, it takes a lot of time to collect a large amount of data of various scenes similar to the scene to be inferred by the recognition model.

For example, a large amount of time is required to collect a large amount of data used for machine learning of a recognition model that recognizes a feature related to a scene (rare scene) having a low appearance frequency. The scene where the appearance frequency is low is, for example, a scene where an abnormality such as a fire occurs in the site environment. In a manufacturing site where a change frequency of a product to be manufactured is high, it takes time and effort to change data used for machine learning according to the product to be manufactured. In a 24-hour site, it is difficult to collect data for a long time by interrupting work. In addition, at a site where privacy protection is required, such as a bathroom, data collection time may be limited, or data collection itself may not be permitted.

In the technique of Patent Literature 1, since the recognition model recognizes a single feature of whether a fire has occurred at the site of the monitoring target, only a label indicating whether a fire has occurred at the site is assigned to a monitoring image of the site used for machine learning of the recognition model. Therefore, it is not easy to obtain data used for machine learning of a recognition model for a scene having a plurality of features by the technology of Patent Literature 1. In addition, Patent Literature 1 describes that an image of a scene where a fire alarm occurs, which is an inference target of a recognition model, is collected from a plurality of different sites where the fire alarm occurs. However, in Patent Literature 1, for example, it is not considered to add new data related to a scene different from a scene to be inferred by a recognition model but similar to the scene, such as an image of a scene where an accident different from a fire has occurred, as data to be used for machine learning of the recognition model.

Therefore, the present inventor has intensively studied a technique capable of efficiently adding data regarding a similar scene different from the scene targeted by the recognition model as data to be newly used for machine learning of the recognition model, and has arrived at each aspect of the present disclosure described below.

(1) A method for generating learning data according to one aspect of the present disclosure is a method for generating learning data used for machine learning of a recognition model that recognizes a feature related to a predetermined scene in a computer, the method including: acquiring first data that is at least one of data used for the machine learning and data erroneously recognized by the recognition model; generating first metadata indicating a characteristic of the first data; acquiring second data related to a scene different from the predetermined scene; generating second metadata indicating a characteristic of the second data; determining whether to newly select the second data as third data to be used for the machine learning based on a similarity between the first metadata and the second metadata; and outputting the third data.

According to this configuration, whether to select the second data related to a scene different from the predetermined scene as the third data to be newly used for the machine learning of the recognition model that recognizes the feature related to the predetermined scene is determined based on the similarity between the first metadata and the second metadata. Therefore, it is possible to efficiently add data regarding a similar scene different from the scene targeted by the recognition model as data to be newly used for machine learning of the recognition model.

(2) In the method for generating learning data according to (1), a characteristic of the first data may include at least one of a feature of an environment in which the first data is generated and a feature of a content of the first data, and a characteristic of the second data may include at least one of a feature of an environment in which the second data is generated and a feature of a content of the second data.

According to this configuration, the third data can be appropriately selected from the second data based on the similarity between a feature of at least one of the environment in which the first data is generated and the content of the first data, and a feature of at least one of the environment in which the second data is generated and the content of the second data.

(3) In the method for generating learning data according to (1), a characteristic of the first data may include a feature recognized from the first data by one or more existing first recognition models, and a characteristic of the second data may include a feature recognized from the second data by one or more existing second recognition models.

According to this configuration, the third data can be appropriately selected from the second data based on the similarity between the feature recognized from the first data by the one or more existing first recognition models and the feature recognized from the second data by the one or more existing second recognition models.

(4) In the method for generating learning data according to any one of (1) to (3), in the determining of whether to select the third data, selecting the second data as the third data in a case where the similarity is larger than a predetermined value may be determined.

According to this configuration, the second data having similar characteristics to the first data can be appropriately selected as the third data.

(5) In the method for generating learning data according to (1), the first data may include a plurality of pieces of first element data, the second data may include a plurality of pieces of second element data, in the generating of the first metadata, a plurality of pieces of first element metadata indicating a characteristic of each of the plurality of pieces of first element data may be generated, in the generating of the second metadata, a plurality of pieces of second element metadata indicating a characteristic of each of the plurality of pieces of second element data may be generated, and in the determining of whether to select the third data, for each of the plurality of pieces of second element data, a plurality of detailed similarities that are degrees of similarity between second element metadata indicating a characteristic of each piece of second element data and the plurality of pieces of first element metadata may be calculated, and whether to select each piece of second element data as the third data may be determined based on the plurality of detailed similarities.

According to the present configuration, for each of the plurality of pieces of second element data, whether to select each piece of the second element data as the third data is determined based on the plurality of detailed similarities that are degrees of similarity between the second element metadata indicating the characteristic of each piece of the second element data and each of the plurality of pieces of first element metadata.

Therefore, in this configuration, even in a case where it is difficult to collect data regarding the predetermined scene, the second element data having similar characteristics to the data used for the machine learning or the data erroneously recognized by the recognition model can be appropriately selected as the third data.

(6) In the method for generating learning data according to (5), in the determining of whether to select the third data: calculating a predetermined number of pieces of second element data are extracted from the plurality of pieces of second element data in order in which a large detailed similarity and selecting each of the predetermined number of pieces of second element data as the third data may be determined.

In this configuration, a predetermined number of pieces of second element data are extracted from the plurality of pieces of second element data in order in which the large detailed similarity is calculated, and each of the predetermined number of pieces of second element data is selected as the third data. Therefore, among the plurality of pieces of second element data, a predetermined number of pieces of second element data having characteristics particularly similar to those of the first element data can be appropriately selected as the third data.

(7) In the method for generating learning data according to (5), in the determining of whether to select the third data: excluding a first predetermined number of pieces of second element data from the plurality of pieces of second element data in order in which a large detailed similarity is calculated; extracting a predetermined number of pieces of second element data from a remaining second element data group in order in which a large detailed similarity is calculated; and selecting each of the predetermined number of pieces of second element data as the third data may be determined.

In this configuration, a predetermined number of pieces of second element data are extracted from the second element data group from which the first predetermined number of pieces of second element data having high detailed similarity are excluded, and each of the predetermined number of pieces of second element data is selected as the third data. Therefore, the second element data having wider characteristics can be selected as the third data.

(8) In the method for generating learning data according to (5), in the determining of whether to select the third data: excluding a first predetermined number of pieces of second element data from the plurality of pieces of second element data in order in which a large detailed similarity is calculated, and excluding a second predetermined number of pieces of second element data in order in which a small detailed similarity is calculated; extracting a predetermined number of pieces of second element data from a remaining second element data group in order in which a large detailed similarity is calculated; and selecting each of the predetermined number of pieces of second element data as the third data may be determined.

In this configuration, a predetermined number of pieces of second element data are extracted from the second element data group from which the second predetermined number of pieces of second element data having a small detailed similarity are excluded, and the predetermined number of pieces of second element data are selected as the third data. Therefore, it is possible to suppress selection of the second element data having characteristics not similar to those of the first element data as the third data. As a result, it is possible to suppress degradation of the accuracy of recognition by the recognition model by performing machine learning using the second element data whose characteristics are not similar to those of the first element data.

(9) In the method for generating learning data according to any one of (6) to (8), in the determining of whether to select the third data, an operation screen displaying the predetermined number of pieces of second element data and a screen component for performing an operation of determining whether to select each of the predetermined number of pieces of second element data as the third data may be displayed on a terminal device used by a user.

According to this configuration, the user can select desired second element data as the third data from the predetermined number of pieces of second element data extracted in the method for generating learning data according to any one of (6) to (8) by operating the screen component displayed on the operation screen.

(10) In the method for generating learning data according to (5), each piece of first element metadata may include one or more characteristics of each piece of first element data, each piece of second element metadata may include one or more characteristics of each piece of second element data, and in the calculating of the plurality of detailed similarities: a characteristic group having a degree of local distribution higher than a predetermined degree may be extracted from at least one plurality of pieces of element metadata among the plurality of pieces of first element metadata and the plurality of pieces of second element metadata; and for each of the plurality of pieces of second element data, a degree of similarity between the characteristic group of each piece of second element data and the characteristic group of each of the plurality of pieces of first element metadata may be calculated as the plurality of detailed similarities.

In this configuration, a characteristic group having a degree of local distribution higher than a predetermined degree is extracted from the at least one plurality of pieces of element metadata. Then, for each of the plurality of pieces of second element data, a degree of similarity between the characteristic group of each piece of second element data and the characteristic group of each of the plurality of pieces of first element metadata is calculated as the plurality of detailed similarities.

Therefore, according to this configuration, it is possible to select, as the third data, the second element data in which a characteristic group in which the degree of local distribution is higher than the predetermined degree and which is considered to have a remarkable feature is similar to the first element data.

(11) In the method for generating learning data according to (5), each piece of first element metadata may indicate one or more characteristics of each piece of first element data, each piece of second element metadata may indicate one or more characteristics of each piece of second element data, and in the calculating of the plurality of detailed similarities: a selection screen displaying information indicating a distribution of each of one or more characteristics indicated by at least one plurality of pieces of element metadata among the plurality of pieces of first element metadata and the plurality of pieces of second element metadata and a screen component for performing an operation of selecting whether each of the one or more characteristics is used for calculating the plurality of detailed similarities may be displayed on a terminal device used by a user; and for each of the plurality of pieces of second element data, a degree of similarity between a characteristic group for which an operation of selecting as a characteristic to be used for calculation of the plurality of detailed similarities is performed on the selection screen among one or more characteristics indicated by each piece of second element data, and the characteristic group indicated by each of the plurality of pieces of first element metadata may be calculated as the plurality of detailed similarities.

In this configuration, the selection screen is displayed on a terminal device used by a user. Then, for each of the plurality of pieces of second element data, a degree of similarity between a characteristic group for which an operation of selecting, among one or more characteristics indicated by each piece of second element data, as a characteristic to be used for calculation of a plurality of detailed similarities is performed on the selection screen and the characteristic group of each of the plurality of pieces of first element metadata is calculated as the plurality of detailed similarities.

Therefore, according to the present configuration, the user can select the characteristic group to be used for calculation of the plurality of detailed similarities by operating the screen component displayed on the selection screen while referring to the information indicating the distribution of each of the one or more characteristics indicated by the at least one plurality of pieces of element metadata.

(12) An information processing device according to another aspect of the present disclosure is an information processing device for generating learning data used for machine learning of a recognition model that recognizes a plurality of features related to a predetermined scene, the information processing device including: a first acquisition unit that acquires first data that is at least one of data used for the machine learning and data erroneously recognized by the recognition model; a first generation unit that generates first metadata indicating a plurality of characteristics of the first data; a second acquisition unit that acquires second data related to a scene different from the predetermined scene; a second generation unit that generates second metadata indicating a plurality of characteristics of the second data; a determination unit that determines whether to newly select the second data as third data to be used for the machine learning based on a similarity between the first metadata and the second metadata; and an output unit that outputs the third data.

According to this configuration, the same operation and effect as those of the method for generating learning data described in (1) can be obtained.

(13) A non-transitory computer readable storage medium according to still another aspect of the present disclosure is a non-transitory computer readable storage medium storing a control program causes a computer, the computer being included in an information processing device for generating learning data used for machine learning of a recognition model that recognizes a plurality of features related to a predetermined scene, to function as: a first acquisition unit that acquires first data that is at least one of data used for the machine learning and data erroneously recognized by the recognition model; a first generation unit that generates first metadata indicating a plurality of characteristics of the first data; a second acquisition unit that acquires second data related to a scene different from the predetermined scene; a second generation unit that generates second metadata indicating a plurality of characteristics of the second data; a determination unit that determines whether to newly select the second data as third data to be used for the machine learning based on a similarity between the first metadata and the second metadata; and an output unit that outputs the third data.

According to this configuration, the same operation and effect as those of the method for generating learning data described in (1) can be obtained.

The present disclosure can also be implemented as an information processing system that is operated by such a control program. It is needless to say that such a computer program can be distributed via a computer-readable non-transitory recording medium such as a CD-ROM or via a communication network such as the Internet.

Each of the embodiments described below illustrates a specific example of the present disclosure. Numerical values, shapes, constituents, steps, order of steps, and the like described in the embodiments below are merely examples, and are not intended to limit the present disclosure. A constituent element not described in an independent claim representing a highest concept among constituent elements in the embodiments below is described as an optional constituent element. In all the embodiments, respective contents can be combined.

### Embodiments

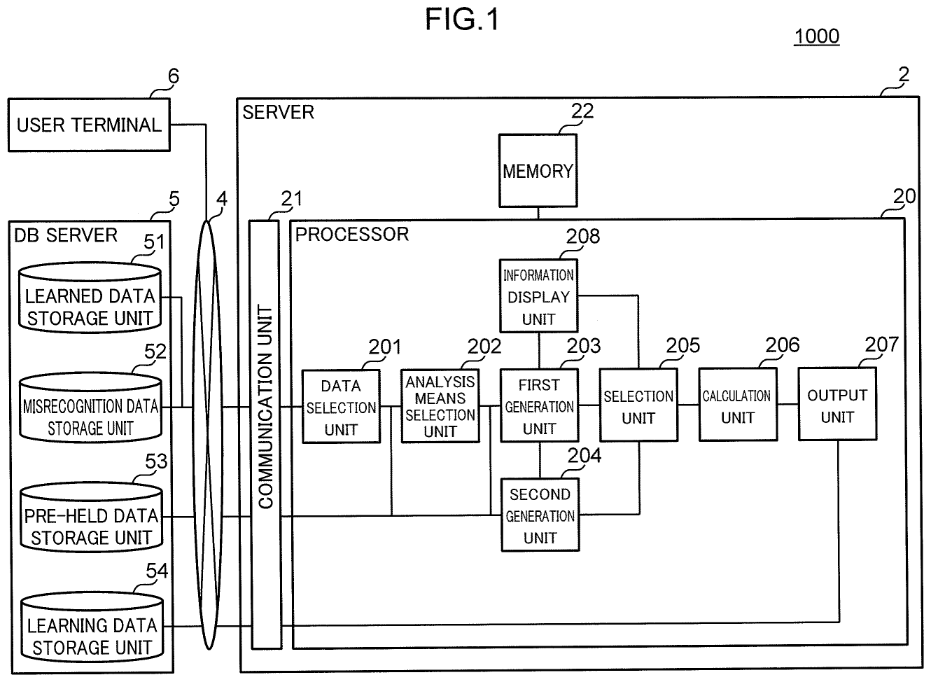

FIG. 1 is a diagram illustrating an overall configuration of an information processing system 1000 according to an embodiment of the present disclosure. The information processing system 1000 includes a server 2 (information processing device), a user terminal 6 (terminal device), and a DB server 5.

The server 2 is communicably connected to the user terminal 6 and the DB server 5 via a network 4. The network 4 is, for example, a wide-area communication network including the Internet and a mobile phone communication network. Although one user terminal 6 is illustrated in FIG. 1, there may be a plurality of user terminals.

The user terminal 6 is used by the user of the information processing system 1000, for example, a portable information processing device such as a tablet computer and a smartphone. The user terminal 6 includes a display that displays various information, a touch panel device that receives various operations, and a communication circuit that connects the user terminal 6 to the network 4.

The DB server 5 is a database server accessible via the network 4. The DB server 5 includes a storage device such as a hard disk drive (HDD) and a solid state drive (SSD), and a communication circuit that connects the DB server 5 to the network 4.

The DB server 5 includes a learned data storage unit 51, a misrecognition data storage unit 52, a pre-held data storage unit 53, and a learning data storage unit 54.

Although one DB server 5 is illustrated in FIG. 1, one or more storage units among the learned data storage unit 51, the misrecognition data storage unit 52, the pre-held data storage unit 53, and the learning data storage unit 54 may be distributed and included in each of the plurality of DB servers 5. Alternatively, a memory 22 of the server 2 may include some of the learned data storage unit 51, the misrecognition data storage unit 52, the pre-held data storage unit 53, and the learning data storage unit 54, and the remaining storage units may be included in one or more DB servers 5.

The learned data storage unit 51 stores data (hereinafter, learned data) used for machine learning of a predetermined authentication model (hereinafter, target model). The target model is a recognition model that recognizes a feature related to a predetermined scene (hereinafter, target scene) from input data and outputs the feature. The target scene is, for example, a scene before and after work is performed in a site environment such as a care site, a manufacturing site, or a shipping site, a scene during work, a scene in which an abnormality occurs in the site environment, or the like. The feature related to the target scene is, for example, an object appearing in the target scene, a place and time at which data indicating the target scene is generated, and the like.

The learned data storage unit 51 further stores the target model and a plurality of authentication models different from the target model. The plurality of authentication models include a single recognition model and a multiple recognition model.

The single recognition model is a recognition model that recognizes a single feature related to a specific scene from input data. For example, the single recognition model includes a recognition model that recognizes whether a person is included in an image indicated by input image data. The single recognition model includes a recognition model that recognizes what is shown in the image indicated by the input image data. The single recognition model includes a recognition model that recognizes whether a fire has occurred at a site where an image indicated by input image data is captured.

The multiple recognition model is a recognition model that recognizes a plurality of features related to a specific scene from input data. For example, the multiple recognition model includes a recognition model that recognizes a plurality of features such as a place where an image indicated by input image data has been photographed, brightness of the place, an object present in the place, and a motion of the object.

The multiple recognition model includes a recognition model that recognizes which region of a road or a building each pixel of the image indicated by the input image data belongs to. The multiple recognition model includes a recognition model that recognizes a position and a size of an object in an image indicated by input image data.

The multiple recognition model includes a recognition model that recognizes a plurality of features such as a language type, a noise amount, a recording environment, and a recording time of the voice indicated by the voice data from the input voice data. The multiple recognition model includes a recognition model that recognizes, from input text data, a plurality of features such as a language type of a text indicated by the text data, an occurrence frequency of each word included in the text, information indicating whether the text indicates a conversation history, and an emotion indicated by the text.

The misrecognition data storage unit 52 stores data erroneously recognized by the target model. The data (hereinafter, misrecognition data) erroneously recognized by the target model is data in which there is an error in one or more features recognized from the data by the target model and data in which the target model cannot recognize the feature from the data.

The pre-held data storage unit 53 stores data (second data) related to a scene different from the target scene. For example, it is assumed that the target scene is a scene of care work of changing clothes in the bathroom. In this case, the pre-held data storage unit 53 stores, for example, data regarding a scene of care work of changing clothes in the bedroom.

In the learning data storage unit 54, data (third data) to be newly used for machine learning of the target model is stored (output) by an output unit 207 to be described later.

Next, a configuration of the server 2 will be described in detail. The server 2 includes a communication unit 21, a memory 22, and a processor 20 (computer).

The communication unit 21 is a communication circuit that connects the server 2 to the network 4. The communication unit 21 transmits the information instructed from the processor 20 to the instructed user terminal 6.

The memory 22 includes, for example, a nonvolatile rewritable semiconductor memory such as a flash memory, a hard disk drive (HDD), or the like. The memory 22 stores a control program executed by the processor 20.

The processor 20 includes, for example, a central processing unit. The processor 20 is able to transmit and receive data to and from the DB server 5 via the network 4 using the communication unit 21.

The processor 20 executes the control program stored in the memory 22 to function as a data selection unit 201 (first acquisition unit), an analysis means selection unit 202, a first generation unit 203, a second generation unit 204 (second acquisition unit), a selection unit 205, a calculation unit 206, an output unit 207 (determination unit), and an information display unit 208. However, this is an example, and the data selection unit 201 to the information display unit 208 may be realized by a dedicated electric circuit such as ASIC that can transmit and receive data to and from the DB server 5 via the network 4 using the communication unit 21.

The data selection unit 201 acquires at least one (hereinafter, first data) of the learned data stored in the learned data storage unit 51 and the misrecognition data stored in the misrecognition data storage unit 52.

Specifically, in accordance with the selection instruction received from the user terminal 6, the data selection unit 201 acquires at least one of the learned data and the misrecognition data from the DB server 5 as the first data. Note that the data selection unit 201 may acquire at least one of predetermined learned data and misrecognition data as the first data without receiving a selection instruction from the user terminal 6.

The analysis means selection unit 202 selects an analysis method of the first data acquired by the data selection unit 201. Specifically, the analysis means selection unit 202 selects a first analysis method and/or a second analysis method as the analysis method of the first data according to the selection instruction received from the user terminal 6.

The first analysis method is an analysis method of deriving a feature of at least one of an environment in which data to be analyzed is generated and content of the data as a characteristic of the data. The second analysis method is an analysis method in which one or more single recognition models and/or multiple recognition models (first recognition model, second recognition model) stored in the learned data storage unit 51 derive a feature recognized from data to be analyzed as a characteristic of the data.

Further, the analysis means selection unit 202 selects an analysis method of the data (hereinafter, second data) stored in the pre-held data storage unit 53, similarly to the case of selecting the analysis method of the first data.

Note that the analysis means selection unit 202 may select an analysis method of the first data and the second data according to setting information stored in advance in the memory 22 instead of the selection instruction received from the user terminal 6. Alternatively, the analysis means selection unit 202 may select the analysis method of the first data and the second data according to the total amount of data stored in the DB server 5 in association with the first data and the second data. Alternatively, the analysis means selection unit 202 may select the analysis method of the first data and the second data according to the number of single recognition models and multiple recognition models stored in the learned data storage unit 51.

The first generation unit 203 derives a characteristic of the first data acquired by the data selection unit 201 by the first data analysis method selected by the analysis means selection unit 202, and generates data (hereinafter, first metadata) indicating the characteristic of the first data.

Specifically, in a case where the analysis means selection unit 202 selects the first analysis method, the first generation unit 203 derives a feature of at least one of the environment in which the first data is generated and the content of the first data as the characteristic of the first data.

For example, it is assumed that data (hereinafter, environment data) indicating a characteristic of an environment in which the device that has generated the first data is installed is stored in the DB server 5 in association with the first data. In this case, the first generation unit 203 acquires the environment data from the DB server 5, and generates the environment data as the first metadata. The features indicated by the environment data include, for example, an installation position and a photographing angle of the camera that has generated the image data, illuminance and temperature in an installation environment of the camera, and the like. The installation position of the camera may be the latitude, longitude, and altitude of the installation position, or may be identification information (for example, “XX company, XX room”) or geographical information (for example, “XX mountain” and “XX riverbed”) of a space including the installation position.

In addition, the first generation unit 203 generates data (hereinafter, content data) indicating a feature of the content of the first data as the first metadata.

Specifically, in a case where the first data is voice data, the features indicated by the content data include the voice quality, the voice speed, the language type, and the like of the voice indicated by the voice data. In a case where the first data is image data, the features indicated by the content data include an average value of color and luminance of an image indicated by the image data, a variance of luminance, an average value of edges, a variance of edges, resolution, and the like.

In a case where the first data includes a plurality of pieces of image data, the recognition accuracy or the degree of rare data of the plurality of pieces of image data by the single recognition model stored in the learned data storage unit 51 may be one feature of the content of the first data. The recognition accuracy by the single recognition model is a ratio of the number of pieces of image data in which a single feature related to a specific scene is recognized by the single recognition model among the plurality of pieces of image data to the total number of the plurality of pieces of image data included in the first data. The degree of rare data by the single recognition model is a ratio of the number of pieces of image data in which a single feature related to a specific scene is not recognized by the single recognition model among the plurality of pieces of image data to the total number of pieces of image data included in the first data.

In a case where the first data includes a plurality of pieces of image data, the total number of pieces of image data included in the first data (the number of pieces of learned data) may be used as the feature of the content of the first data. In addition, the first generation unit 203 may use a caption indicating the content of the first data generated by known caption generation processing as a feature of the content of the first data.

On the other hand, in a case where the analysis means selection unit 202 selects the second analysis method, the first generation unit 203 generates, as the first metadata, data indicating a feature recognized from the first data by one or more single recognition models and/or multiple recognition models stored in the learned data storage unit 51.

For example, in a case where the first data is image data, the features recognized by the multiple recognition model from the first data include a place where the image indicated by the image data is photographed, brightness of the place, an object present in the place, an operation of the object, and the like. In a case where the first data is image data, the feature recognized from the first data by the multiple recognition model may include a region (for example, a road, a building, or the like) to which each pixel of the image indicated by the image data belongs. In a case where the first data is image data, the feature recognized from the first data by the multiple recognition model may include the position and size of each object included in the image indicated by the image data.

In a case where the first data is voice data, the features recognized by the multiple recognition model from the first data may include a language type of voice indicated by the voice data, a noise amount, a recording environment, a recording time, and the like. In a case where the first data is text data, the features recognized by the multiple recognition model from the first data may include a language type of a text indicated by the text data, an occurrence frequency of each word included in the text, information indicating whether the text indicates a conversation history, an emotion indicated by the text, and the like.

In addition, in a case where the first data includes a plurality of pieces of data (hereinafter, first element data), the first generation unit 203 generates a plurality of pieces of first element metadata indicating respective characteristics of the plurality of pieces of first element data as the first metadata.

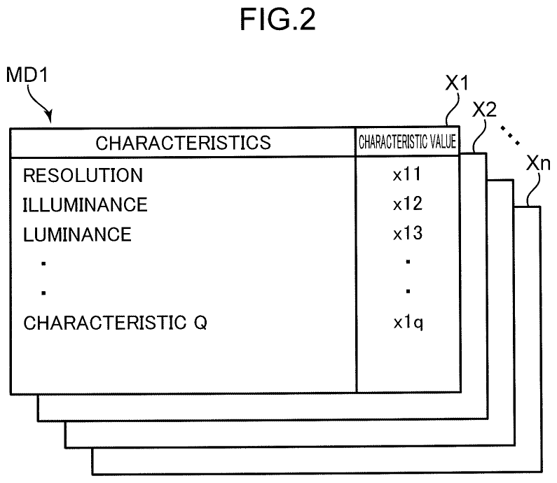

FIG. 2 is a diagram illustrating an example of the first metadata MD1. FIG. 2 illustrates an example in which in a case where the first data includes n pieces of first element data, the first generation unit 203 generates n pieces of first element metadata X1 to Xn indicating characteristics of the n pieces of first element data as the first metadata MD1. For example, the first element metadata X1 illustrated in FIG. 2 indicates the characteristics ‘resolution is “x11”’, ‘illuminance is “x12”’, ‘“luminance is “x13”’, . . . ‘“characteristic Q is “x1q”’ of the first element data.

The second generation unit 204 acquires the second data stored in the pre-held data storage unit 53. Similarly to the first generation unit 203, the second generation unit 204 derives a characteristic of the acquired second data by the analysis method of the second data selected by the analysis means selection unit 202, and generates data (hereinafter, second metadata) indicating the characteristic of the second data.

In a case where the second data includes a plurality of pieces of data (hereinafter, second element data), the second generation unit 204 generates a plurality of pieces of second element metadata indicating characteristics of the plurality of pieces of second element data as the second metadata, similarly to the first generation unit 203.

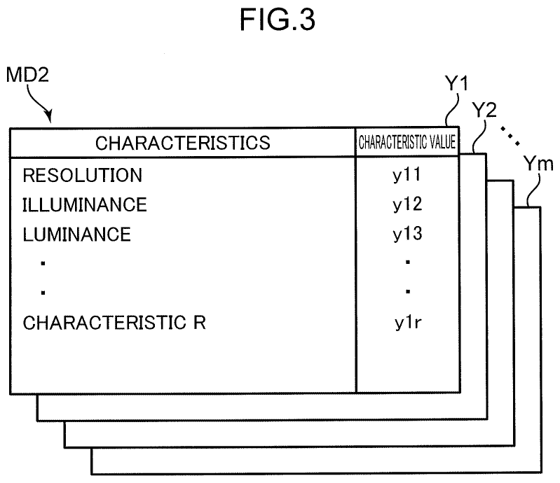

FIG. 3 is a diagram illustrating an example of second metadata MD2. FIG. 3 illustrates an example in which in a case where the second data includes m pieces of second element data, the second generation unit 204 generates m pieces of second element metadata Y1 to Ym indicating characteristics of the m pieces of second element data as the second metadata MD2. For example, the second element metadata Y1 illustrated in FIG. 3 indicates the characteristics ‘“resolution is “y11”’, ‘“illuminance is “y12”’, ‘“luminance is “y13”’, . . . “characteristic R is “y1r”’ of the second element data.

The selection unit 205 selects a characteristic group (hereinafter, comparative characteristic group) to be compared between the first metadata and the second metadata.

Specifically, the selection unit 205 extracts a type group (for example, “resolution” and “illuminance”) of characteristics common to the first metadata and the second metadata. The selection unit 205 selects each type of characteristic included in the type group in the first metadata (for example, ‘resolution is “x11”’ and ‘illuminance is “x12”’) and each type of characteristic included in the type group in the second metadata (for example, ‘resolution is “y11”’ and ‘“illuminance is “y12”’) as the comparative characteristic group.

It is assumed that the first metadata includes a plurality of pieces of first element metadata, and the second metadata includes a plurality of pieces of second element metadata. In this case, the selection unit 205 selects, as the comparative characteristic group, a characteristic group in which a degree of local distribution is higher than a predetermined degree from at least one plurality of pieces of element metadata among the plurality of pieces of first element metadata included in the first metadata and the plurality of pieces of second element metadata included in the second metadata. Note that the at least one plurality of pieces of element metadata is, in other words, a plurality of pieces of first element metadata, a plurality of pieces of second element metadata, or a plurality of pieces of first element metadata and a plurality of pieces of second element metadata. In this case, a characteristic group in which the degree of local distribution is higher than the predetermined degree and which is considered to have a remarkable characteristic can be selected as the comparative characteristic group.

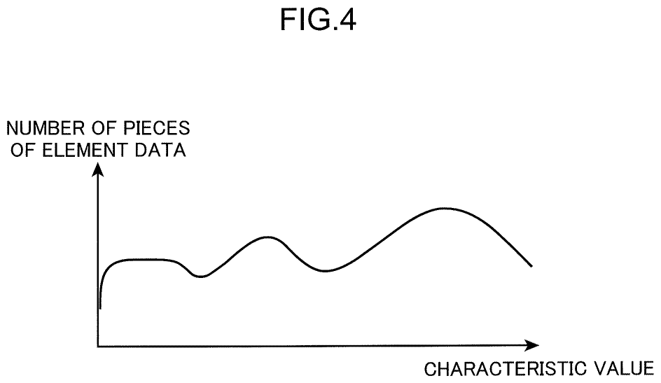

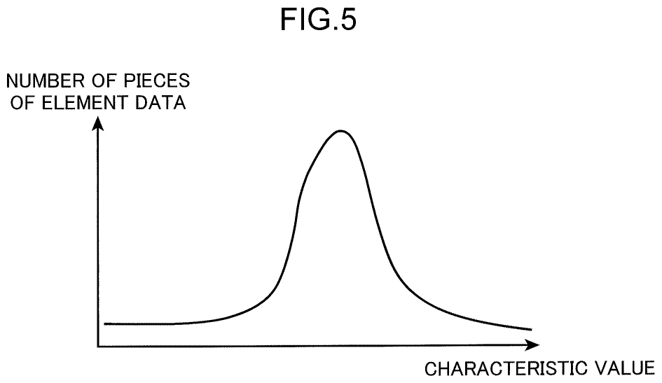

FIG. 4 is a diagram illustrating an example of a distribution of characteristics in which a degree of local distribution is lower than a predetermined degree. FIG. 5 is a diagram illustrating an example of a distribution of characteristics in which a degree of local distribution is higher than a predetermined degree. In FIGS. 4 and 5, the horizontal axis indicates values (characteristic values) of one characteristic in the at least one plurality of pieces of element metadata, and the vertical axis indicates the number of pieces of element metadata having the one characteristic in the at least one plurality of pieces of element metadata.

For each of one or more characteristics indicated by the element metadata, the selection unit 205 calculates a variance and an entropy of each characteristic as an index indicating a distribution of each characteristic in the at least one plurality of pieces of element metadata.

For example, as illustrated in FIG. 4, the distribution of the characteristic having both the large variance and the large entropy is a distribution having a low degree of local distribution. For example, as illustrated in FIG. 5, the distribution of the characteristic having the small variance and entropy becomes a distribution having a large degree of local distribution. Therefore, among the one or more characteristics indicated by the element metadata, the selection unit 205 selects a characteristic group in which the variance is smaller than a predetermined first threshold and the entropy is smaller than a predetermined second threshold as a characteristic in which the degree of local distribution is higher than a predetermined degree.

Alternatively, the selection unit 205 may transmit, to the user terminal 6, an instruction to display a selection screen displaying information indicating a distribution of each of one or more characteristics indicated by the at least one plurality of pieces of element metadata and a screen component for performing an operation of selecting each of the one or more characteristics as a comparative characteristic group. In this case, the user can select the comparative characteristic group by operating the screen component displayed on the selection screen while referring to the information indicating the distribution of each of the one or more characteristics.

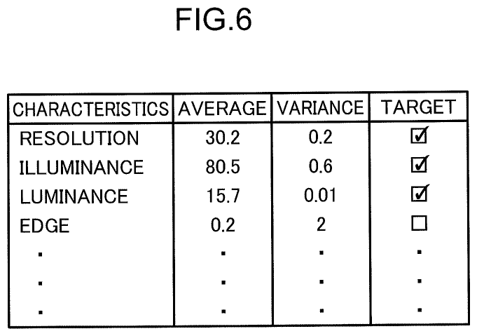

FIG. 6 is a diagram illustrating a first example of the selection screen. FIG. 6 illustrates an example in which, as the information indicating the distribution of each of the one or more characteristics indicated by the at least one plurality of pieces of element metadata, four characteristic type groups “resolution”, “illuminance”, “luminance”, and “edge” indicated by the element metadata, average values “30.2”, “80.5”, “15.7”, and “0.2”, and variances “0.2”, “0.6”, “0.01”, and “2” of the values of the respective types of characteristics are displayed, and the user performs an operation to select three characteristic type groups “resolution”, “illuminance”, and “luminance” on a selection screen on which four check boxes are displayed as the screen component.

In this case, the user terminal 6 returns information indicating the type groups “resolution”, “illuminance”, and “luminance” of the three characteristics to the server 2. The selection unit 205 selects characteristics of the type groups “resolution”, “illuminance”, and “luminance” indicated by the information received from the user terminal 6 in each of the plurality of pieces of first element metadata and the plurality of pieces of second element metadata as a comparative characteristic group.

Note that the selection unit 205 may display, on the selection screen, a graph indicating the distribution of each of the one or more characteristics indicated by the at least one plurality of pieces of element metadata as information indicating the distribution of each of the one or more characteristics indicated by the at least one plurality of pieces of element metadata.

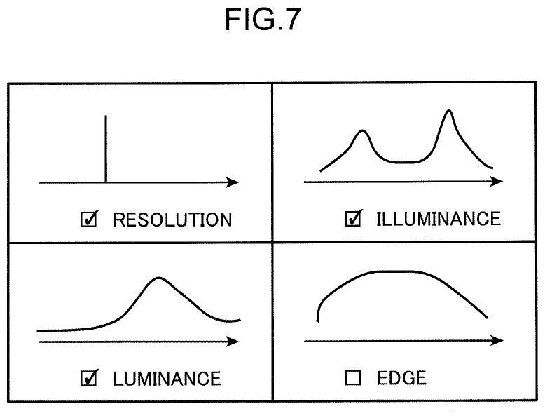

FIG. 7 is a diagram illustrating a second example of the selection screen. FIG. 7 illustrates an example in which a graph indicating the distribution of each of four types of characteristic groups “resolution”, “illuminance”, “luminance”, and “edge” in the at least one plurality of pieces of element metadata is displayed as the information indicating the distribution of each of the one or more characteristics indicated by the at least one plurality of pieces of element metadata, and the user performs an operation to select three types of characteristic groups “resolution”, “illuminance”, and “luminance” on a selection screen on which four check boxes are displayed as the screen component.

In this case, the user terminal 6 returns information indicating the three types of characteristic groups “resolution”, “illuminance”, and “luminance” to the server 2. The selection unit 205 selects the three types of characteristic groups “resolution”, “illuminance”, and “luminance” indicated by the information received from the user terminal 6 in each of the plurality of pieces of first element metadata and the plurality of pieces of second element metadata as a comparative characteristic group.

The calculation unit 206 calculates similarity between the first metadata and the second metadata.

Specifically, the calculation unit 206 calculates the reciprocal (=1/distance) of the distance between the values of the comparative characteristic group selected by the selection unit 205 in each of the first metadata and the second metadata as the similarity between the first metadata and the second metadata. The distance of the value of the comparative characteristic group in each of the first metadata and the second metadata is any one of an L2 distance, an L1 distance, a Mahalanobis distance, and KL (Kullback-Leibler) divergence between the value of the comparative characteristic group of the first metadata and the value of the comparative characteristic group of the second metadata.

In a case where the first data includes a plurality of pieces of first element data and the second data includes a plurality of pieces of second element data, the first metadata includes a plurality of pieces of first element metadata, and the second metadata includes a plurality of pieces of second element metadata. In this case, the calculation unit 206 calculates, for each of the plurality of pieces of second element data, a plurality of detailed similarities that are degrees of similarity between the second element metadata indicating the characteristic of each piece of second element data and each of the plurality of pieces of first element metadata.

Specifically, for each of the plurality of pieces of second element data, the calculation unit 206 calculates the reciprocal (=1/distance) of the distance between the value of the comparative characteristic group in the second element metadata indicating the characteristic of each piece of second element data and the value of the comparative characteristic group in each of the plurality of pieces of first element metadata. The calculation unit 206 calculates the reciprocal of the distance as the detailed similarity between the second element metadata indicating the characteristic of each piece of second element data and each of the plurality of pieces of first element metadata. Note that the method of the detailed similarity by the calculation unit 206 is not limited thereto, and may be a method of calculating a larger detailed similarity as the distance is smaller, such as calculating a product of the distance and −1 as the detailed similarity.

The distance between the value of the comparative characteristic group in the second element metadata indicating the characteristic of the second element data and the value of the comparative characteristic group in the first element metadata is any one of the L2 distance, the L1 distance, the Mahalanobis distance, and the KL divergence between the value of the comparative characteristic group in the second element metadata and the value of the comparative characteristic group in the first element metadata.

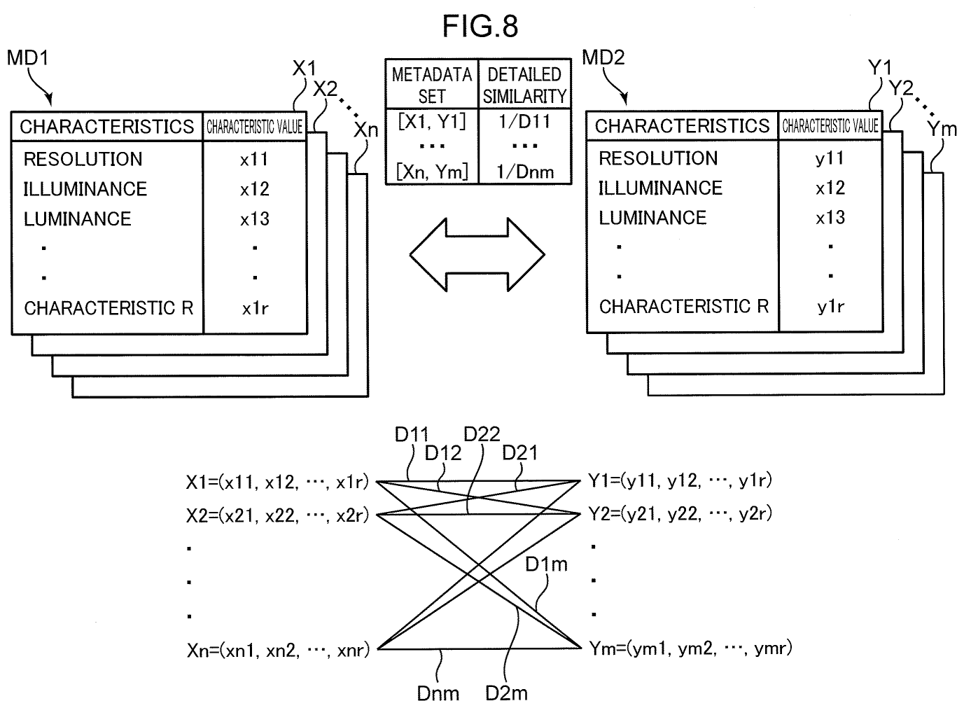

FIG. 8 is a diagram illustrating a calculation example of the detailed similarity. For example, FIG. 8 illustrates an example in which the calculation unit 206 calculates m×n detailed similarities in a case where the first metadata MD1 includes n pieces of first element metadata X1, X2, . . . , and Xn indicating the characteristics of the n pieces of first element data included in the first data, and the second metadata MD2 includes m pieces of second element metadata Y1, Y2, . . . , and Ym indicating the characteristics of the m pieces of second element data included in the second data.

For example, FIG. 8 illustrates an example in which the calculation unit 206 calculates the detailed similarity “1/D11” of a set [X1, Y1] of the first second element metadata Y1 and the first first element metadata X1. Specifically, the reciprocal “1/D11” of the distance D11 between the value “y11, y12, . . . , y1r” of the comparative characteristic group of the first second element metadata Y1 indicating the characteristic of the first second element data and the value “x11, x12, . . . , x1r” of the comparative characteristic group of the first first element metadata X1 is calculated as the detailed similarity “1/D11”of the set [X1, Y1].

In addition, FIG. 8 illustrates an example in which the calculation unit 206 calculates the detailed similarity “1/Dnm” of a set [Xn, Ym] of the m-th second element metadata Ym and the n-th first element metadata Xn. Specifically, the reciprocal “1/Dnm” of the distance Dnm between the value “ym1, ym2, . . . , ymr” of the comparative characteristic group of the m-th second element metadata Ym indicating the characteristic of the m-th second element data and the value “xn1, xn2, . . . , xnr” of the comparative characteristic group of the n-th first element metadata Xn is calculated as the detailed similarity “1/Dnm”of the set [Xn, Ym].

The output unit 207 determines whether to select the second data as the third data to be newly used for machine learning based on the similarity between the first metadata and the second metadata, and outputs the third data. In other words, the output unit 207 outputs, as the third data, the second data determined to be selected as the third data.

Specifically, in a case where the similarity between the first metadata and the second metadata is larger than a predetermined value, the output unit 207 determines to select the second data whose characteristic is indicated by the second metadata as the third data. As a result, the second data having similar characteristics to the first data can be appropriately selected as the third data.

The output unit 207 stores the second data determined to be selected as the third data in the learning data storage unit 54 (FIG. 1) as the third data. Note that this is an example, and the output unit 207 may transmit (output), as the third data, the second data determined to be selected as the third data to an external information processing device that performs machine learning of the target model using the communication unit 21.

On the other hand, in a case where the similarity between the first metadata and the second metadata is equal to or less than the predetermined value, the output unit 207 determines not to select the second data whose characteristic is indicated by the second metadata as the third data. In this case, the output unit 207 does not perform the processing of storing the second data as the third data in the learning data storage unit 54 (FIG. 1).

In a case where the first data includes a plurality of pieces of first element data and the second data includes a plurality of pieces of second element data, the first metadata includes a plurality of pieces of first element metadata, and the second metadata includes a plurality of pieces of second element metadata. In this case, the calculation unit 206 calculates, for each of the plurality of pieces of second element data, a plurality of detailed similarities that are degrees of similarity between the second element metadata indicating the characteristic of each piece of second element data and each of the plurality of pieces of first element metadata.

In this case, the output unit 207 determines to select, as the third data, each of the second element data groups in which the detailed similarity greater than the predetermined value is calculated among the plurality of pieces of second element data.

Alternatively, the output unit 207 determines to extract a predetermined number of pieces of second element data from the plurality of pieces of second element data in order in which the large detailed similarity is calculated, and select each of the predetermined number of pieces of second element data as the third data. In this case, among the plurality of pieces of second element data, a predetermined number of pieces of second element data having a characteristic particularly similar to that of the first element data can be appropriately selected as the third data.

For example, as illustrated in FIG. 8, it is assumed that the first metadata MD1 includes n pieces of first element metadata X1, X2, . . . , and Xn indicating characteristics of n pieces of first element data included in the first data. In addition, it is assumed that the second metadata MD2 includes m pieces of second element metadata Y1, Y2, . . . , and Ym indicating the characteristics of the m pieces of second element data included in the second data. In this case, it is assumed that the calculation unit 206 calculates m×n detailed similarities. The predetermined number is assumed to be N.

In this case, the output unit 207 determines to extract N pieces of detailed similarity in descending order from among the m×n pieces of detailed similarity, and select, as the third data, each of the N pieces of second element data for which the extracted N pieces of detailed similarity have been calculated.

A plurality of pieces of the same second element data may overlap the predetermined number of pieces of the second element data determined to be selected as the third data. In this case, the output unit 207 repeats the processing of extracting the next largest detailed similarity and determining to select, as the third data, the second element data for which the detailed similarity has been calculated until the number of different second element data determined to be selected as the third data reaches a predetermined number.

Alternatively, the output unit 207 may exclude a first predetermined number (for example, N1) of pieces of second element data from the plurality (for example, m) of pieces of second element data in order in which the large detailed similarity is calculated. Then, the output unit 207 may determine to select each of a predetermined number (for example, N) of pieces of second element data as the third data in order in which the large detailed similarity is calculated, in the same manner as described above, from the remaining (for example, m−N1) second element data groups. In this case, the second element data having wider characteristics than the above method can be selected as the third data.

Note that the output unit 207 may exclude, from the plurality of second element data, second element data for which a detailed similarity within a range from the maximum detailed similarity to a detailed similarity smaller than the maximum detailed similarity by a predetermined value or more is calculated in order in which the large detailed similarity is calculated.

Alternatively, the output unit 207 may exclude a first predetermined number (for example, N1) of pieces of second element data from a plurality (for example, m) of pieces of second element data in order in which a large detailed similarity is calculated, and exclude a second predetermined number (for example, N2) of pieces of second element data in order in which a small detailed similarity is calculated. Thereafter, the output unit 207 may determine to select each of a predetermined number (for example, N) of pieces of second element data as the third data in order in which the large detailed similarity is calculated, in the same manner as described above, from the remaining (for example, m−N1−N2) second element data groups.

In this case, it is possible to suppress selection of the second element data having characteristics not similar to those of the first element data as the third data as compared with the above method. As a result, it is possible to suppress degradation of the accuracy of recognition by the target model by performing machine learning using the second element data whose characteristics are not similar to those of the first element data.

Note that the output unit 207 may exclude, from the plurality of second element data, second element data for which a detailed similarity within a range from the maximum detailed similarity to a detailed similarity smaller than the maximum detailed similarity by a predetermined value or more is calculated in order in which the large detailed similarity is calculated. In accordance with this, the output unit 207 may exclude, from the plurality of second element data, second element data for which a detailed similarity within a range from the minimum detailed similarity to a detailed similarity larger than the minimum detailed similarity by a predetermined value or more is calculated in order in which the small detailed similarity is calculated.

Furthermore, the output unit 207 may transmit, to the user terminal 6, an instruction to display an operation screen displaying a predetermined number of pieces of second element data determined to be selected as the third data by any of the above methods and a screen component for performing an operation of selecting each of the predetermined number of pieces of second element data as the third data.

In this case, the user can visually recognize the predetermined number of pieces of second element data displayed on the operation screen, select second element data considered to be appropriate as the third data from the predetermined number of pieces of second element data, and select only desired second element data as the third data.

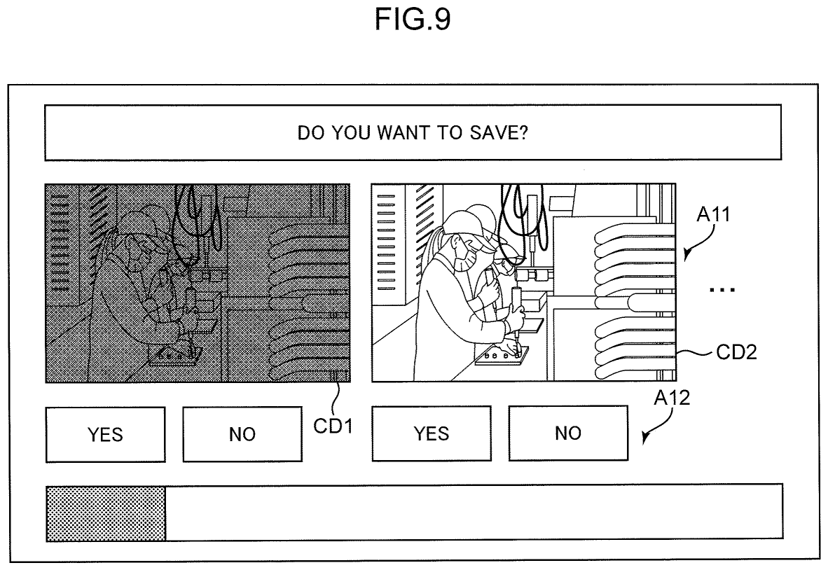

FIG. 9 is a diagram illustrating an example of the operation screen. FIG. 9 illustrates an example of an operation screen on which a display field A11 of the predetermined number of pieces of second element data determined to be selected as the third data by the output unit 207 by any of the above methods and a display field A12 of the screen component for performing an operation of selecting each of the predetermined number of pieces of second element data as the third data are displayed.

The operation screen illustrated in FIG. 9 illustrates an example in which the user terminal 6 puts a first second element data CD1 into a non-selected state in a case where an operation of not selecting the first second element data CD1 as the third data is performed. The operation of not selecting the first second element data CD1 as the third data is an operation of pressing the button “NO” displayed in the display field A12 below the first second element data CD1.

In addition, the operation screen illustrated in FIG. 9 illustrates an example in which the user terminal 6 displays the second second element data CD2 in a case where the operation of selecting the second second element data CD2 as the third data is performed or in a case where the operation of not selecting the second second element data CD2 as the third data is not performed. The operation of selecting the second second element data CD2 as the third data is an operation of pressing the button “YES” displayed in the display field A12 below the second second element data CD2.

In this case, the user terminal 6 returns, to the server 2, information indicating the second element data group for which the operation of selecting as the third data has been performed. The output unit 207 determines to select, as the third data, each of the second element data groups indicated by the information received from the user terminal 6 among the predetermined number of pieces of second element data determined to be selected as the third data by any one of the methods described above.

In accordance with the instruction received from the user terminal 6, the information display unit 208 generates a display screen on which an operation of displaying various types of information is possible, and returns an instruction to display the display screen to the user terminal 6.

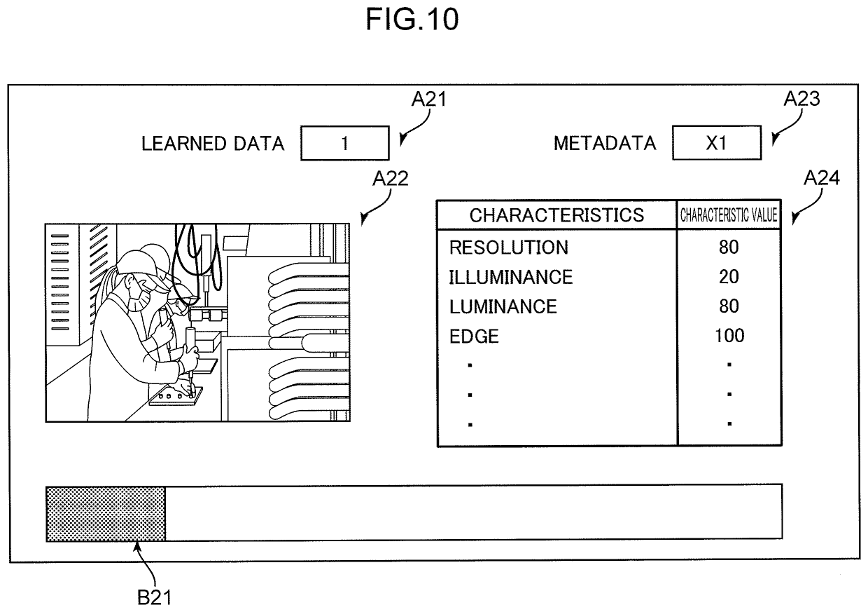

FIG. 10 is a diagram illustrating a first example of the metadata display screen. FIG. 10 illustrates an example of a display screen which is generated by the information display unit 208 and on which the plurality of pieces of first element data included in the first metadata and the first element metadata indicating the characteristic of each of the plurality of pieces of first element data can be displayed.

Specifically, the display screen of FIG. 10 illustrates an example in which the first element data corresponding to the identification information “1” input in the input field A21 is displayed in the display field A22, the first element metadata indicating the characteristic of the first element data is displayed in the display field A24, and the identification information “X1” of the first element metadata is displayed in the display field A23. In the display screen of FIG. 10, the identification information input to the input field A21 is changed by the operation of the scroll bar B21, and the contents displayed in the display fields A22 to A24 are also updated accordingly.

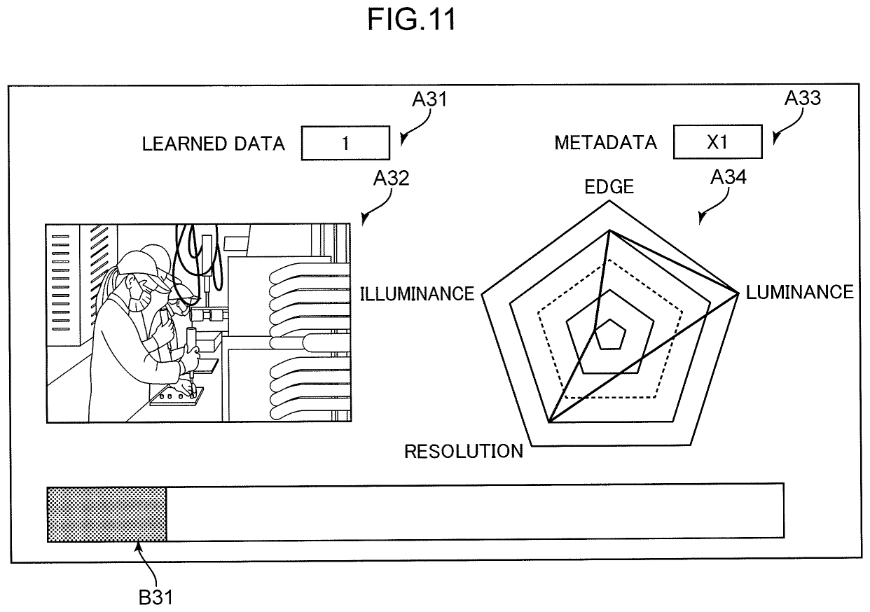

FIG. 11 is a diagram illustrating a second example of the metadata display screen. FIG. 11 illustrates another example of the display screen generated by the information display unit 208. The display screen of FIG. 11 is different from the display screen illustrated in FIG. 10 in the display form of the first element metadata.

Specifically, the display screen of FIG. 11 illustrates an example in which the first element data corresponding to the identification information “1” input in the input field A31 is displayed in the display field A32, and the radar chart indicating the content of the first element metadata indicating the characteristic of the first element data is displayed in the display field A34. In addition, the display screen of FIG. 11 illustrates an example in which the identification information “X1” of the first element metadata is displayed in the display field A33. In the display screen of FIG. 11, the identification information input to the input field A31 is changed by the operation of the scroll bar B31, and the contents displayed in the display fields A32 to A34 are also updated accordingly.

In addition, similarly to the selection screen illustrated in FIGS. 6 and 7, the information display unit 208 may generate the display screen displaying the information indicating the distribution of each of the one or more characteristics indicated by the plurality of pieces of first element metadata according to the instruction received from the user terminal 6, and may return the instruction to display the display screen to the user terminal 6. In addition, similarly to the selection screen illustrated in FIGS. 6 and 7, the information display unit 208 may generate the display screen displaying the information indicating the distribution of each of the one or more characteristics indicated by the plurality of pieces of second element metadata according to the instruction received from the user terminal 6, and may return the instruction to display the display screen to the user terminal 6.

By displaying the display screen on the user terminal 6, the user can visually recognize the characteristics of the plurality of pieces of first element data. Therefore, this configuration is suitable for the user to consider what kind of characteristic data should be selected as data to be newly used for machine learning of the target model.

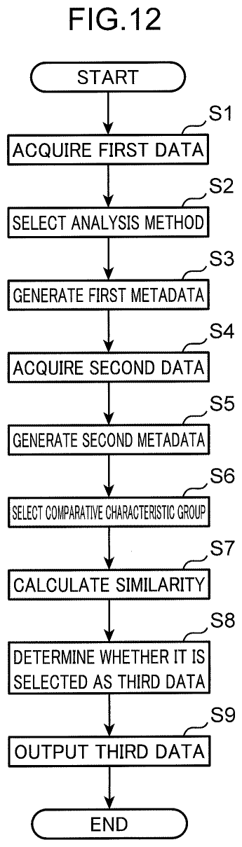

The configuration of the server 2 has been described above. Next, the processing of the server 2 will be described. FIG. 12 is a flowchart presenting an example of the processing of the server 2.

In the server 2, the processor 20 newly starts data generation processing (hereinafter, learning data generation processing) used for machine learning of the target model at a predetermined timing. The predetermined timing may be, for example, a timing at which the communication unit 21 receives an instruction to execute the learning data generation processing from the user terminal 6, a timing at which a predetermined amount or more of the second data is stored in the pre-held data storage unit 53, or a periodic timing such as once a month.

As illustrated in FIG. 12, when the learning data generation processing is started, the data selection unit 201 acquires the first data (step S1). Next, the analysis means selection unit 202 selects an analysis method of the first data acquired in step S1 (step S2).

Next, the first generation unit 203 derives the characteristic of the first data acquired in step S1 by the analysis method of the first data selected in step S2, and generates the first metadata indicating the characteristic of the first data (step S3).

In a case where the first data acquired in step S1 includes a plurality of pieces of first element data, in step S3, the first generation unit 203 generates a plurality of pieces of first element metadata indicating characteristics of the plurality of pieces of first element data as the first metadata.

Next, the second generation unit 204 acquires the second data stored in the pre-held data storage unit 53 (step S4). Then, the second generation unit 204 derives the characteristic of the second data acquired in step S4 by the analysis method of the second data selected in step S2, and generates the second metadata indicating the characteristic of the second data (step S5).

In a case where the first data acquired in step S4 includes a plurality of pieces of first element data, the second generation unit 204 generates a plurality of pieces of second element metadata indicating characteristics of the plurality of pieces of second element data as the second metadata in step S5.

Next, the selection unit 205 selects a comparative characteristic group to be a target when comparing the first metadata generated in Step S3 with the second metadata generated in Step S5 (Step S6).

It is assumed that the first metadata generated in step S3 includes a plurality of pieces of first element metadata, and the second metadata generated in step S5 includes a plurality of pieces of second element metadata. In this case, in step S6, the selection unit 205 selects a comparative characteristic group from at least one plurality of pieces of element metadata among the plurality of pieces of first element metadata and the plurality of pieces of second element metadata.

Next, the calculation unit 206 calculates a similarity between the first metadata and the second metadata by using values of the comparative characteristic group selected in step S6 in each of the first metadata and the second metadata (step S7).

It is assumed that the first metadata generated in step S3 includes a plurality of pieces of first element metadata, and the second metadata generated in step S5 includes a plurality of pieces of second element metadata. In this case, in step S7, the calculation unit 206 calculates, for each of the plurality of pieces of second element data, a plurality of detailed similarities that are degrees of similarity between the second element metadata indicating the characteristic of each piece of second element data and each of the plurality of pieces of first element metadata.

Next, the output unit 207 determines whether to newly select the second data as the third data to be used for machine learning based on the similarity between the first metadata and the second metadata calculated in step S7 (step S8).

Note that, in step S7, it is assumed that the calculation unit 206 calculates, for each of the plurality of pieces of second element data, a plurality of detailed similarities that are degrees of similarity between the second element metadata indicating the characteristic of each piece of second element data and each of the plurality of pieces of first element metadata. In this case, the output unit 207 determines whether to select each piece of the second element data as the third data based on the plurality of detailed similarities.

After step S8, the output unit 207 newly outputs the second data determined to be selected as the third data in step S8 as the third data to be used for machine learning of the target model (step S9).

As described above, in the configuration of the present embodiment, whether to select the second data related to the scene different from the target scene as the third data to be newly used for the machine learning of the target model is determined based on the similarity between the first metadata and the second metadata. Therefore, in this configuration, the second data having similar characteristics to the data used for the machine learning of the target model can be newly output as the data to be used for the machine learning of the target model. As a result, various third data similar to the target scene can be efficiently collected.

Therefore, in this configuration, the second data having similar characteristics to the data erroneously recognized by the target model can be newly output as the data used for the machine learning of the target model. As a result, it is possible to improve accuracy of erroneous recognition by the target model by performing machine learning of the target model using the third data.

According to the present disclosure, since data regarding a scene different from a scene targeted by a recognition model can be newly added as data to be used for machine learning of the recognition model, it is useful in collecting learning data to be used for machine learning of a recognition model that recognizes a feature of a predetermined scene.

1. A method for generating learning data used for machine learning of a recognition model that recognizes a feature related to a predetermined scene in a computer, the method comprising:
acquiring first data that is at least one of data used for the machine learning and data erroneously recognized by the recognition model;
generating first metadata indicating a characteristic of the first data;
acquiring second data related to a scene different from the predetermined scene;
generating second metadata indicating a characteristic of the second data;
determining whether to newly select the second data as third data to be used for the machine learning based on a similarity between the first metadata and the second metadata; and
outputting the third data.

2. The method for generating learning data according to claim 1, wherein
a characteristic of the first data includes at least one of a feature of an environment in which the first data is generated and a feature of a content of the first data, and
a characteristic of the second data includes at least one of a feature of an environment in which the second data is generated and a feature of a content of the second data.

3. The method for generating learning data according to claim 1, wherein
a characteristic of the first data includes a feature recognized from the first data by one or more existing first recognition models, and
a characteristic of the second data includes a feature recognized from the second data by one or more existing second recognition models.

4. The method for generating learning data according to claim 1, wherein
in the determining of whether to select the third data,
selecting the second data as the third data in a case where the similarity is larger than a predetermined value is determined.

5. The method for generating learning data according to claim 1, wherein
the first data includes a plurality of pieces of first element data,
the second data includes a plurality of pieces of second element data,
in the generating of the first metadata, a plurality of pieces of first element metadata indicating a characteristic of each of the plurality of pieces of first element data is generated,
in the generating of the second metadata, a plurality of pieces of second element metadata indicating a characteristic of each of the plurality of pieces of second element data is generated, and
in the determining of whether to select the third data,
for each of the plurality of pieces of second element data, a plurality of detailed similarities that are degrees of similarity between second element metadata indicating a characteristic of each piece of second element data and the plurality of pieces of first element metadata are calculated, and whether to select each piece of second element data as the third data is determined based on the plurality of detailed similarities.

6. The method for generating learning data according to claim 5, wherein
in the determining of whether to select the third data:
extracting a predetermined number of pieces of second element data from the plurality of pieces of second element data in order in which a large detailed similarity; and
selecting each of the predetermined number of pieces of second element data as the third data is determined.

7. The method for generating learning data according to claim 5, wherein
in the determining of whether to select the third data:
excluding a first predetermined number of pieces of second element data from the plurality of pieces of second element data in order in which a large detailed similarity is calculated;
extracting a predetermined number of pieces of second element data from a remaining second element data group in order in which a large detailed similarity is calculated; and
selecting each of the predetermined number of pieces of second element data as the third data is determined.

8. The method for generating learning data according to claim 5, wherein
in the determining of whether to select the third data:
excluding a first predetermined number of pieces of second element data from the plurality of pieces of second element data in order in which a large detailed similarity is calculated, and excluding a second predetermined number of pieces of second element data in order in which a small detailed similarity is calculated;
extracting a predetermined number of pieces of second element data from a remaining second element data group in order in which a large detailed similarity is calculated; and
selecting each of the predetermined number of pieces of second element data as the third data is determined.

9. The method for generating learning data according to claim 6, wherein
in the determining of whether to select the third data,
an operation screen displaying the predetermined number of pieces of second element data and a screen component for performing an operation of determining whether to select each of the predetermined number of pieces of second element data as the third data is displayed on a terminal device used by a user.

10. The method for generating learning data according to claim 5, wherein
each piece of first element metadata includes one or more characteristics of each piece of first element data,
each piece of second element metadata includes one or more characteristics of each piece of second element data, and
in the calculating of the plurality of detailed similarities:
a characteristic group having a degree of local distribution higher than a predetermined degree is extracted from at least one plurality of pieces of element metadata among the plurality of pieces of first element metadata and the plurality of pieces of second element metadata; and
for each of the plurality of pieces of second element data, a degree of similarity between the characteristic group of each piece of second element data and the characteristic group of each of the plurality of pieces of first element metadata is calculated as the plurality of detailed similarities.

11. The method for generating learning data according to claim 5, wherein
each piece of first element metadata indicates one or more characteristics of each piece of first element data,
each piece of second element metadata indicates one or more characteristics of each piece of second element data, and
in the calculating of the plurality of detailed similarities:
a selection screen displaying information indicating a distribution of each of one or more characteristics indicated by at least one plurality of pieces of element metadata among the plurality of pieces of first element metadata and the plurality of pieces of second element metadata and a screen component for performing an operation of selecting whether each of the one or more characteristics is used for calculating the plurality of detailed similarities is displayed on a terminal device used by a user; and
for each of the plurality of pieces of second element data, a degree of similarity between a characteristic group for which an operation of selecting as a characteristic to be used for calculation of the plurality of detailed similarities is performed on the selection screen among one or more characteristics indicated by each piece of second element data, and the characteristic group indicated by each of the plurality of pieces of first element metadata is calculated as the plurality of detailed similarities.

12. An information processing device for generating learning data used for machine learning of a recognition model that recognizes a plurality of features related to a predetermined scene, the information processing device comprising:
a first acquisition unit that acquires first data that is at least one of data used for the machine learning and data erroneously recognized by the recognition model;
a first generation unit that generates first metadata indicating a plurality of characteristics of the first data;
a second acquisition unit that acquires second data related to a scene different from the predetermined scene;
a second generation unit that generates second metadata indicating a plurality of characteristics of the second data;
a determination unit that determines whether to newly select the second data as third data to be used for the machine learning based on a similarity between the first metadata and the second metadata; and
an output unit that outputs the third data.

13. A non-transitory computer readable storage medium storing a control program for causing a computer, the computer being included in an information processing device for generating learning data used for machine learning of a recognition model that recognizes a plurality of features related to a predetermined scene, to function as:
a first acquisition unit that acquires first data that is at least one of data used for the machine learning and data erroneously recognized by the recognition model;
a first generation unit that generates first metadata indicating a plurality of characteristics of the first data;
a second acquisition unit that acquires second data related to a scene different from the predetermined scene;
a second generation unit that generates second metadata indicating a plurality of characteristics of the second data;
a determination unit that determines whether to newly select the second data as third data to be used for the machine learning based on a similarity between the first metadata and the second metadata; and
an output unit that outputs the third data.
